(19) United States
(12) Patent Application Publication
(10) Pub. No.: US 2022/0135818 A1
(43) Pub. Date: May 5, 2022

(54) WHITE INK COMPOSITIONS

(71) Applicant: Hewlett-Packard Development Company, L.P., Spring, TX (US)

(72) Inventors: Dennis Z. GUO, San Diego, CA (US); Jie ZHENG, San Diego, CA (US); Barbara Casanas MONTES, Aguadilla, PR (US); Marcos A. CABAN, Aguadilla, PR (US)

(73) Assignee: Hewlett-Packard Development Company, L.P., Spring, TX (US)

(21) Appl. No.: 17/433,263

(22) PCT Filed: Nov. 25, 2019
(86) PCT No.: PCT/US2019/062910

§ 371 Date: Aug. 24, 2021

(51) Int. Cl. C09D 11/322; C09D 11/102; C09D 11/037; C09D 11/107; C09D 11/033; B41M 5/00; B41J 2/21

(52) U.S. Cl. CPC C09D 11/322; C09D 11/102; C09D 11/037; B41J 2/2114; C09D 11/033; B41M 5/0023; C09D 11/107

(57) ABSTRACT

A white ink composition can include an aqueous ink vehicle including water and organic co-solvent, from 5 wt % to 30 wt % white metal oxide pigment, from 0.05 wt % to 1 wt % block copolymer dispersant adsorbed on a surface of the white metal oxide, and from 2 wt % to 30 wt % polyurethane binder. The block copolymer dispersant can have a weight average molecular weight from 5,000 Mw to 20,000 Mw and an acid number from 0 mg KOH/g to 40 mg KOH/g based on dry weight of the block copolymer dispersant.

### BACKGROUND

The use of ink-jet printing systems has grown in recent years, which may be attributed to enhancements in print resolution and overall print quality coupled with appreciable reduction in cost. Today's ink-jet printers offer acceptable print quality for many commercial, business, and household applications at lower costs than comparable products available just a few years ago. Notwithstanding their recent success, research and development efforts continue toward improving ink-jet print quality over a wide variety of different applications.

### BRIEF DESCRIPTION OF THE DRAWINGS

FIG. 1 illustrates an example white ink composition in accordance with examples of the present disclosure;

FIG. 2 is a flow chart illustrating an example method of making a white ink composition in accordance with the present disclosure;

FIG. 3 is a flow chart illustrating an example method of printing a white ink composition in accordance with the present disclosure; and

FIG. 4 illustrates an example system that is usable for printing a white ink composition in accordance with the present disclosure.

### DETAILED DESCRIPTION

The present disclosure is drawn to white ink compositions, namely water-based white ink composition jet inks that can be jetted from various types of inkjet printheads, but can be particularly friendly for use in thermal inkjet printheads. These inks can be printed not only on porous media, but also effectively on non-porous polymer media.

In accordance with examples of the present disclosure, a white ink composition includes an aqueous ink vehicle including water and organic co-solvent, from 5 wt % to 30 wt % white metal oxide pigment, from 0.05 wt % to 1 wt % block copolymer dispersant adsorbed on a surface of the white metal oxide, and from 2 wt % to 30 wt % polyurethane binder. The block copolymer dispersant has a weight average molecular weight from 5,000 Mw to 20,000 Mw and an acid number from 0 mg KOH/g to 40 mg KOH/g based on dry weight of the block copolymer dispersant. In one example, the white ink composition can include from 50 wt % to 85 wt % water and from 5 wt % to 25 wt % polyol organic co-solvent. In another example, the white metal oxide pigment can include titanium dioxide particles, zinc oxide particles, zirconium oxide particles, cerium dioxide particles, or a combination thereof. The white metal oxide pigment can have a D50 particle size from 100 nm to 2,000 nm. The block copolymer dispersant can be, for example, a branched copolymer with polyether pendant chains and acidic groups. The polyurethane binder can have a weight average molecular weight from 20,000 Mw to 500,000 Mw and an acid number from 0 mg KOH/g to 40 mg KOH/g based on dry weight of the polyurethane binder. In another example, the polyurethane binder can be an anionic aliphatic polyester- or polyether-polyurethane. In other examples, the white ink composition can be substantially devoid of dispersed aluminum oxides, dispersed silicon dioxides, and high-acid polymers having an acid number of 100 mg KOH/g or more.

In another example, a method of making a white ink composition includes combining a white metal oxide pigment in a water-based carrier with a block copolymer dispersant to form a white metal oxide pigment dispersion, and admixing the white metal oxide pigment dispersion with water, organic co-solvent, and polyurethane binder to form the white ink composition. The block copolymer dispersant in this example is adsorbed on a surface of the white metal oxide and has a weight average molecular weight from 5,000 Mw to 20,000 Mw and an acid number from 0 mg KOH/g to 40 mg KOH/g based on dry weight of the block copolymer dispersant. The white ink composition prepared in this example includes from 5 wt % to 30 wt % of the white metal oxide pigment, from 0.05 wt % to 1 wt % of the polymer dispersant, and from 2 wt % to 30 wt % of the polyurethane binder. In one example, the combining can include milling the white metal oxide pigment with the polymer dispersant. In another example, the polymer dispersant can be a branched copolymer with polyether pendant chains and acidic groups. In further detail, the polyurethane binder can have a weight average molecular weight from 20,000 Mw to 500,000 Mw and an acid number from 0 mg KOH/g to 40 mg KOH/g based on dry weight of the polyurethane binder. The white ink composition prepared can include from 50 wt % to 85 wt % water and from 5 wt % to 25 wt % polyol organic co-solvent.

In another example, a method of printing a white ink composition includes remixing a white ink composition including an aqueous ink vehicle, white metal oxide pigment, block copolymer dispersant, and a polyurethane binder, wherein remixing causes re-suspension of the white metal oxide pigment that has settled in the aqueous ink vehicle; and ejecting the white ink composition from an inkjet printhead after the white metal oxide pigment has been re-suspended wherein the block copolymer dispersant is adsorbed on a surface of the white metal oxide. The block copolymer dispersant in this example has a weight average molecular weight from 5,000 Mw to 20,000 Mw and an acid number from 0 mg KOH/g to 40 mg KOH/g based on dry weight of the block copolymer dispersant. In one example, the remixing can be carried out by: rotation of an ink cartridge or supply containing the white ink composition; recirculation of the white ink composition within fluidics of a printer, within the ink cartridge or supply, or both; agitation of the white ink composition within the ink cartridge or supply; or a combination thereof.

When describing the white ink compositions and/or related methods, such descriptions can be considered applicable to one another whether or not they are explicitly discussed in the context of that example. Thus, for example, when discussing a white metal oxide pigment related to the white ink composition, such disclosure is also relevant to and directly supported in the context of the methods, and vice versa.

Terms used herein will have the ordinary meaning in their technical field unless specified otherwise. In some instances, there are terms defined more specifically throughout the specification or included at the end of the present specification, and thus, these terms can have a meaning as described herein.

### White Ink Compositions

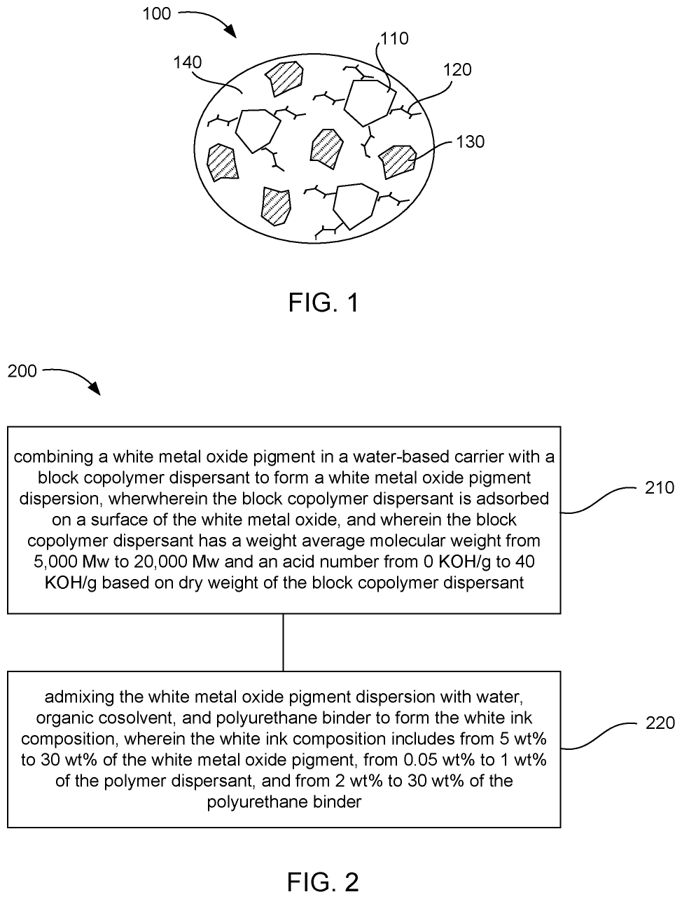

FIG. 1 illustrates an example white ink composition 100 in accordance with examples of the present disclosure. In this example, the white ink composition can include white metal oxide pigment 110, a block copolymer dispersant 120 adsorbed on a surface of the white metal oxide, a polyurethane binder 130, and an aqueous ink vehicle 140. The white metal oxide pigment can be zinc oxide, titanium dioxide such as rutile or anatase, zirconium oxide, cerium dioxide, or the like, for example. The block copolymer dispersant in this example can have a weight average molecular weight from 5,000 Mw to 20,000 Mw and an acid number from 0 mg KOH/g to 40 mg KOH/g based on dry weight of the block copolymer dispersant. The polyurethane binder can also have a low acid number, e.g., from 0 mg KOH/g to 40 mg KOH/g. The aqueous ink vehicle can include water and organic co-solvent, and may also include other ingredients, such as surfactant(s), biocide(s), viscosity modifier, chelating agent, etc.

Turning now to the various specific ingredients that are present in the white ink composition, there can be a white metal oxide pigment included in the white ink compositions. The white metal oxide pigments (e.g., zinc oxide, titanium dioxide such as rutile or anatase, zirconium oxide, cerium dioxide, etc.) can be dispersed and effectively jetted from thermal inkjet printheads with non-ionic or predominantly non-ionic dispersants. Unfortunately, these types of dispersions also tend to settle rapidly and sediments tend to be difficult to re-suspend. Thus, the present disclosure provides for the preparation and use of ink compositions that are stable in solution, and when they do settle, can be easily re-suspended with gentle agitation, for example.

The white pigment provides much of the white coloration to the ink, though without the other ingredients in the ink, the pigment may have some transparency or translucency. The term “white metal oxide pigment” refers to pigments that impart a white color to an ink, but may in fact be essentially colorless pigments with a high refractive index, e.g., greater than 1.6 or greater than 1.8. For Example, titanium dioxide (TiO₂) is an example of such a pigment that imparts white color to an ink, but when viewed on a particle by particle basis, can appear colorless. Examples of white metal oxide pigments that can be used include titanium dioxide particles, zinc oxide particles, zirconium oxide particles, cerium dioxide particles, combinations thereof, or the like. Pigments with high light scatter capabilities, such as these, can be selected to enhance light scattering and lower transmittance, thus increasing opacity. White metal oxide pigments can have a D50 particle size from greater than 100 nm to 2,000 nm, and more typically, from 125 nm to 1,000 nm, from 125 nm to 700 nm, and in still another example, from 150 nm to 500 nm. The combination of these pigments within these size ranges, appropriately spaced from one another with ingredients such as the polyurethane binder, can achieve 100% opacity at relatively thin thickness, e.g., 5 gsm to 50 gsm after removal of water and other co-solvent(s) from the printed ink and fixer film.

The white metal oxide pigment, among other solids that may be present, can be dispersed using a non-ionic or low anionic dispersing agent. Suitable block copolymer dispersants can allow for suitable dispersibility and stability in an aqueous ink environment, while having little to no impact on the viscosity of the liquid phase of the ink as well as retaining good printhead reliability in thermal inkjet printheads. These block copolymer dispersants can, in some examples, be non-ionic or predominantly non-ionic (only weakly anionic). For definitional purposes, the term “non-ionic or low anionic” when referring to dispersants, includes predominantly non-ionic (or weakly anionic) dispersants, provided the acid number of the predominantly non-ionic/weak anionic dispersant, per dry polymer, is not higher than 40 mg KOH/g. That being stated, in one example, non-ionic dispersing agent with no anionic properties can be used.

Examples of block copolymer dispersants that can be used include water-dispersible or soluble low-to-midrange weight, e.g., from 5,000 Mw to 20,000 Mw or from 5,000 Mw to 15,000 Mw, branched copolymers, such as those with comb-structures and polyether pendant chains and acidic anchor groups attached to a backbone thereof, e.g., Disperbyk®-190, Disperbyk®-199, etc., available from BYK Chemie (Germany), or Dispersogen® PCE, available from Clariant (Switzerland). Weight average molecular weight (Mw) may be measurable by Gel Permeation Chromatography with polystyrene standard, or by some other equivalent standard.

A dispersion of white metal oxide pigment suitable for forming the white ink compositions of the present disclosure can be prepared via milling or dispersing metal oxide powder in water in the presence of suitable dispersants. For example, the metal oxide dispersion may be prepared by milling commercially available inorganic oxide pigment having large D50 particle size (in the micron range) in the presence of the dispersants described above until the desired particle size is achieved. The starting dispersion to be milled can be an aqueous dispersion with solid content up to 65% by weight of the white metal oxide pigment or pigments. The milling equipment that can be used may be a bead mill, which is a wet grinding machine capable of using very fine beads having diameters of less than 1.0 mm (and, generally, less than 0.5 mm) as the grinding medium, for example, Ultra-Apex Bead Mills from Kotobuki Industries Co. Ltd. The milling duration, rotor speed, and/or temperature may be adjusted to achieve the dispersion D50 particle size.

There can also be advantages of adding the polyurethane binder to the inks of the present disclosure. For example, by combining white metal oxide pigment with the polyurethane binder, opacity can be increased, even though the polyurethane binder does not have a high refractive index. In one aspect, a white metal oxide pigment to polyurethane binder weight ratio can be from 10:1 to 1:5, from 5:1 to 1:3, or from 3:1 to 1:2.

In further detail, in providing some optical spacing between white metal oxide pigment particles by interposing particles of the polyurethane binder therebetween, opacity can be increased compared to inks without the polyurethane binder present. In other words, a layer of more densely packed high refractive index white metal oxide pigment can actually be less opaque (to light) than a layer of less densely packed white metal oxide pigment (e.g., pigment crowding effect). It may be considered counterintuitive because one expects better light scattering capability and opacity of coating to have a higher concentration of high refractive index white metal oxide pigment. Thus, in certain examples, by decreasing the density of the white metal oxide pigment or pigment content, and replacing the pigment with essentially colorless polyurethane binder particles, opacity could actually be increased.

A wide variety of polyurethane binders can be used for this purpose. The polyurethane may be aliphatic (straight-chained, branched, and/or alicyclic) or aromatic, or may be any of a variety of types of polyurethane. In certain more specific examples, the polyurethane binder can be an anionic aliphatic polyester-polyurethane. In another example, the polyurethane binder can be an anionic aliphatic polyether-polyurethane. Some specific examples of commercially available aliphatic waterborne polyurethanes include Sancure® 1514, Sancure® 1591, Sancure® 2260, and Sancure® 2026 (all of which are available from Lubrizol Inc.). Some specific examples of commercially available castor oil-based polyurethanes include Alberdingkusa® CUR 69, Alberdingkusa® CUR 99, and Alberdingkusa® CUR 991 (all from Alberdingk Boley Inc.). Other example polyurethanes that can be used include several available from Covestro (Germany), such as Dispercoll® U42 (anionic aliphatic polyester-polyurethane dispersion; 33,000 Mw; 5.5 mg KOH/g Acid Number); Impranil® DLN-SD (anionic aliphatic polyester-polyurethane dispersion; 45,000 Mw; 5.2 mg KOH/g Acid Number); and/or Impranil® DP DSB 1069 (anionic aliphatic polyether-polyurethane dispersion; 95,000 Mw; 3.6 mg KOH/g Acid Number. These and others may be carboxylated and/or sulfonated, for example.

As mentioned, the D50 particle size of the white metal oxide pigment can be from greater than 100 nm to 2,000 nm, but in other examples, the D50 particle size can be from 125 nm to 1,000 nm, from 125 nm to 750 nm, or from 150 nm to 500 nm. These larger sized particles are considered to be efficient particle sizes for light scattering when spaced appropriately by the particles provided by the polyurethane binder. The more efficient the light scattering, typically, the more opaque the printed ink layer may be (assuming appropriate spacing in the pigmented layer as described herein). Thus, the white ink compositions of the present disclosure can be formulated such that when printed, the polyurethane binder particles provide an average space between white metal oxide pigments ranging from 20 nm to 2,000 nm, in one example. In other examples, the average space between white metal oxide pigments (as provided primarily by the polyurethane binder) can be 50 nm to 500 nm, from 150 to 300, or in more specific examples, 220 nm to 300 nm or 220 nm to 260 nm.

In addition to assisting with enhanced opacity, as briefly mentioned, the polyurethane binder can also provide enhanced durability. Thus, the polyurethane binder can provide the dual role of enhancing opacity by appropriately spacing the white metal oxide pigment, and can also provide durability to the printed image on the media sheet. This is particularly the case in examples where there may be high metal oxide particle loads that are dispersed by appropriate dispersing agents. Films formed by hard ceramic particles (such as high refractive index metal oxides on surfaces of low porosity and non-porous media substrates) in absence of any binder material tend to have poor mechanical properties. The film-forming behavior of polyurethane binder described herein can bind the relatively large white metal oxide pigment (with dispersing agent present in the ink) into continuous coating that can be very durable.

Regarding the polyurethane binder, these particles can have various shapes, sizes, and molecular weights. In one example, polymer in the polyurethane binder may have a weight average molecular weight (Mw) 20,000 Mw to 500,000 Mw, from 25,000 Mw to 400,000 Mw, from 30,000 Mw to 300,000 Mw, or from 40,000 Mw to 200,000 Mw, for example.

The polyurethane binder can, in some examples, have an acid number from 0 mg KOH/g to 40 mg KOH/g, from 0 mg KOH/g to 30 mg KOH/g, from 0 mg KOH/g to 20 mg KOH/g, from 0 mg KOH/g to 10 mg KOH/g, from 1 mg KOH/g to 40 mg KOH/g, from 1 mg KOH/g to 30 mg KOH/g, from 1 mg KOH/g to 20 mg KOH/g, or from 1 mg KOH/g to 10 mg KOH/g, for example, based on dry weight of the polyurethane binder.

Further, the D50 particle size of the polyurethane binder can be from 10 nm to 1 μm, from 10 nm to 500 nm, from 50 nm to 500 nm, or from 50 nm to 300 nm, for example. The particle size distribution of the polyurethane binder is not particularly limited. It is also possible to use two or more kinds of polyurethane binder, for example.

In some examples, other than the white metal oxide pigment(s), the white ink composition can be substantially devoid of dispersed particles of metal oxides or semi-metal oxides, such as dispersed aluminum oxides, e.g., boehmite, dispersed silicon dioxides, etc. The white ink composition can in other examples be substantially devoid of “high-acid polymer,” which is defined herein as having an acid number of 100 mg KOH/g or more. In one example, other than the white metal oxide pigment(s), the white ink composition can be substantially devoid of metal oxides, semi-metal oxides, and high-acid polymers. In still further detail, the white ink composition can be substantially devoid of any compound having an acid number higher than 100 mg KOH/g, higher than 60 mg KOH/g, or higher than 40 mg KOH/g. The term “substantially devoid” indicates that there is none of these specifically enumerated ingredients present, or if there is some present, it is present at such a deminimis concentration that it does not interfere with the other components, e.g., present in aggregate of less than 1 wt %, less than 0.5 wt %, or less than 0.1 wt %, if present at all.

The white ink compositions of the present disclosure also include an aqueous ink vehicle. As used herein, “aqueous ink vehicle” refers to a water-containing liquid fluid in which the white metal oxide pigment and the polyurethane binder is dispersed to form an ink. A wide variety of ink vehicles may be used with the white ink compositions and methods of the present technology. Such ink vehicles may include a mixture of a variety of different agents, including, water, organic co-solvent, surfactant, anti-kogation agent, buffer, biocide, sequestering agent, viscosity modifier, surface-active agent, etc. Though not part of the ink vehicle per se, the ink vehicle can carry other solid additives as well, such as polyurethane binder, pigment and dispersants, etc. In one aspect, water can include a majority component of the ink vehicle, meaning it is present at a higher concentration than any other ingredient, and in some instances, the water may be present at over 50 wt % of the white ink composition.

Classes of co-solvents that can be used can include organic co-solvents including aliphatic alcohols, aromatic alcohols, diols, glycol ethers, polyglycol ethers, 2-pyrrolidinones, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, or the like. In certain particular examples, the aqueous ink vehicle can include a polyol organic co-solvent(s), such as a C2 to C6 diol(s) or triol(s). For example, the polyol(s), in aggregate, may be included in the white ink composition at from 5 wt % to 25 wt %. More specific examples of polyols that can be used include 1,3-propanediol, 2-methyl-1,3-propanediol, 1,5-pentanediol, glycerol, e.g., 1,2,3-propanetriol. Other organic co-solvents that are monoalcohols can also be included in some examples, such as Dowanol™ TPM from Dow (USA), which includes one alcohol and a plurality of ether groups.

Consistent with the formulation of this disclosure, various other additives may be employed to enhance the properties of the ink composition for specific applications. Examples of these additives are those added to inhibit the growth of harmful microorganisms. These additives may be biocides, fungicides, and other microbial agents, which can be used in the white ink compositions. Examples of suitable microbial agents include, but are not limited to, NUOSEPT® (Nudex, Inc.), UCARCIDE™ (Union carbide Corp.), VANCIDE® (R.T. Vanderbilt Co.), PROXEL® (ICI America), and combinations thereof.

Viscosity modifiers and buffers may also be present, as well as other additives known to those skilled in the art to modify properties of the ink as desired. Such additives can be present at from 0.01 wt % to 20 wt %.

Methods of Making and Printing with White Ink Compositions

As illustrated in FIG. 2 a method 200 of making a white ink composition in accordance with the present disclosure can include combining 210 a white metal oxide pigment in a water-based carrier with a block copolymer dispersant to form a white metal oxide pigment dispersion, wherein the block copolymer dispersant is adsorbed on a surface of the white metal oxide, and wherein the block copolymer dispersant has a weight average molecular weight from 5,000 Mw to 20,000 Mw and an acid number from 0 mg KOH/g to 40 mg KOH/g based on dry weight of the block copolymer dispersant. In further detail, the method can also include admixing 220 the white metal oxide pigment dispersion with water, organic co-solvent, and polyurethane binder to form the white ink composition. The white ink composition can include from 5 wt % to 30 wt % of the white metal oxide pigment, from 0.05 wt % to 1 wt % of the polymer dispersant, and from 2 wt % to 30 wt % of the polyurethane binder.

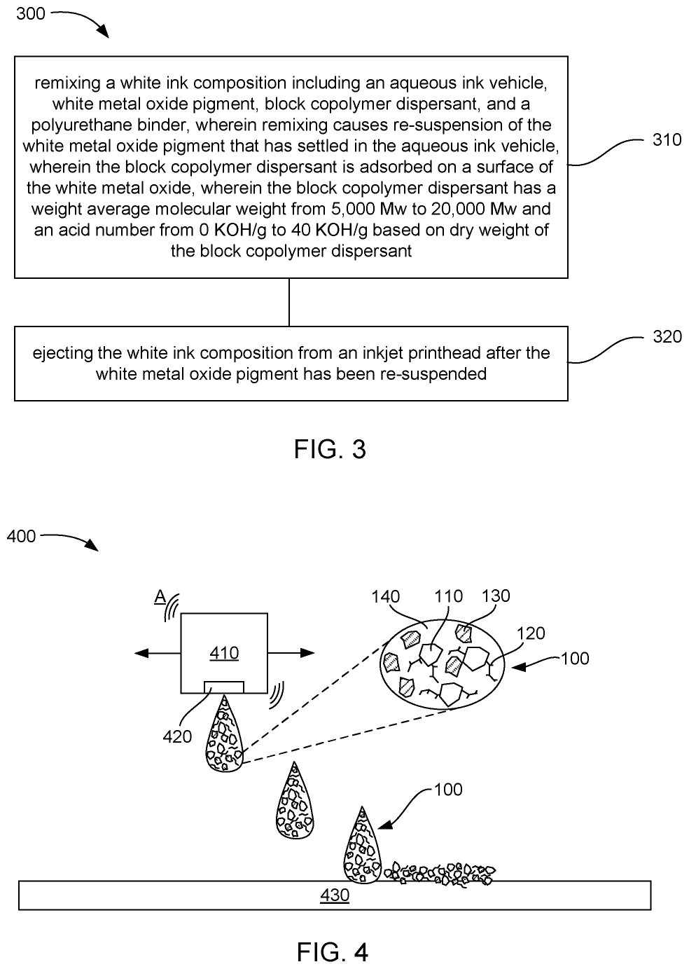

In another example, as illustrated in FIG. 3, a method 300 of printing a white ink composition can include remixing 310 a white ink composition including an aqueous ink vehicle, white metal oxide pigment, block copolymer dispersant, and a polyurethane binder, and ejecting 320 the white ink composition from an inkjet printhead after the white metal oxide pigment has been re-suspended. In this example, remixing can cause re-suspension of the white metal oxide pigment that has settled in the aqueous ink vehicle. The block copolymer dispersant in this example is adsorbed on a surface of the white metal oxide. In further detail, the block copolymer dispersant has a weight average molecular weight from 5,000 Mw to 20,000 Mw and an acid number from 0 mg KOH/g to 40 mg KOH/g based on dry weight of the block copolymer dispersant. Remixing can be carried out in a number of ways. For example, the white ink composition vessel, e.g., ink cartridge or supply container, can rotated, e.g., vertically or end over end, or rotated in some other way to cause the white metal oxide pigment to become suspended (or re-suspended). Remixing can be through recirculation of the white ink composition within fluidics of a printer, within the ink cartridge or supply, or both. Remixing may likewise be by agitation or other mechanical vibration or movement to cause the white metal oxide pigment to become re-suspended in the aqueous ink vehicle. Any combination of these remixing techniques or others can be used in accordance with the present disclosure.

FIG. 4 illustrates an example system 400 that is usable for printing a white ink composition 100 in accordance with the present disclosure. The white ink composition can be prepared and described in FIG. 1 and elsewhere herein, for example, with a white metal oxide pigment 110, a block copolymer dispersant 120 adsorbed on a surface of the white metal oxide, a polyurethane binder 130, and an aqueous ink vehicle 140. Printing can be carried out on any type of print media 430, such as paper, fabric, plastic film, or the like. In this example, there is a container 410, which can be an ink cartridge, for example, where the ink can be recirculated (shown schematically at “A”) to re-suspend settled white metal oxide pigment that may have settled in the white ink composition. The container where remixing (such as rotation, ink circulation, agitation, etc.) occurs can be at any location, but is shown in this example as being at an ink cartridge, which also includes an inkjet printhead 420.

In accordance with examples herein, the white ink composition can be applied to the media substrate at from 0.5 grams per square meter (gsm) to 100 gsm, from 1 gsm to 75 gsm, or from 1 gsm to 50 gsm, from 3 gsm to 75 gsm, from 3 gsm to 50 gsm, or from 4 gsm to 40 gsm, for example. After water and co-solvent(s) evaporation, or in some instances, after heat fusing with a heating source, the grams per square meter may translate to 10 wt % to 60 wt % of the initial fluid dispersion flux density, e.g., less than 60 gsm. In one example, a fully inked area may be applied and dried, leaving from 30 gsm to 50 gsm ink/fixer film, but densities lower in the tone ramp may be lower than this. Furthermore, some areas on a media substrate may be at 0 gsm white ink composition in unprinted areas (or areas not printed with the white ink composition). That stated, on a typical printed article, there is a portion of the media that can be printed and dried to leave from 5 gsm to 50 gsm, which is inclusive of the white ink composition and other ink compositions that may also be printed therewith, for example.

It is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

### Definitions

It is be noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Furthermore, it is understood that any reference to open ended transition phrases such as “comprising” or “including” directly supports the use of other known, less open ended, transition phrases such as “consisting of” or “consisting essentially of” and vice versa.

“D50” particle size is defined as the particle size at which about half of the particles are larger than the D50 particle size and about half of the other particles are smaller than the D50 particle size (by weight based on the particle content). As used herein, D50 particle size with respect to the white metal oxide pigment and the polyurethane binder, for example, can be based on volume of the particle size, which is modified to the volume of a spherical shape for diameter measurement, for example. D50 Particle size (and/or other particle size distribution data) can be collected using a Malvern ZETASIZER™ from Malvern Panalytical (United Kingdom), for example.

The term “acid number” refers to acid value, which is the mass of potassium hydroxide (KOH) in milligrams that can be used to neutralize one gram of substance (mg KOH/g), such as the polyurethane binders disclosed herein. This value can be determined by dissolving or dispersing a known quantity of a material in organic solvent and then titrating with a solution of potassium hydroxide (KOH) of known concentration for measurement.

Weight average molecular weight (Mw) can be measured by gel permeation chromatography with polystyrene standard, for example.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. Additionally, a numerical range with a lower end of “0” can include a sub-range using “0.1” as the lower end point.

### EXAMPLES

The following illustrates some examples of the disclosed inks, printed articles, and methods that are presently known. However, it is to be understood that the following are only exemplary or illustrative of the application of the principles of the present disclosure. Numerous modifications and alternative examples may be devised by those skilled in the art without departing from the spirit and scope of the present compositions and methods.

### Example 1—Preparation of White Pigment Dispersions

Two white pigment dispersions (D1 and D2) were prepared by milling TiO₂ pigment powder in water-based slurry containing polymer dispersant. Both D1 and D2 included 55 wt % of the white metal oxide pigment. However, D1 included 1.1 wt % Disperbyk®-190 block copolymer dispersant (glycol ether and polystyrene-acrylic acid) and D2 included 0.44 wt % wt Disperbyk®-190 and 0.275 wt % Carbosperse® K-7208 polyacrylic acid dispersant. The balance of the two white pigment dispersions was about 44 wt % water. The milling was carried out in a MicroMedia™ mill (available from Bühler Group, Switzerland) utilizing YTZ milling beads with 0.3 mm diameter. The TiO₂ white metal oxide pigment in this example was coated with small concentrations of silica and alumina. The D50 particle size of the TiO₂ in the dispersion was about 240-275 nm, as may be verified or determined using a NANOTRACK® particle size analyzer (Microtrack Corp., Montgomeryville, Pa.). The two white pigment dispersions are shown in Table 1, as follows:

TABLE 1
White Pigment Dispersions

| | | D1 | D2 |
|---|---|---|---|
| Component | Category | (wt%) | (wt%) |
| TiO₂ | White Metal Oxide Pigment | 55 | 55 |
| Disperbyk ®-190 | Block Copolymer | 1.1 | 0.44 |
| | Dispersant | | |
| Carbosperse ® K-7208 | High-Acid Polymer | — | 0.275 |
| Water | Solvent | Balance | Balance |

Titanium Dioxide is Ti-Pure ® R960, available from DuPont USA, which includes a small amount of silica and alumina coated to a surface thereof, e.g., 6.5 wt% and 3.5 wt%, respectively.
Disperbyk ®-190 is a glycol ether and poly(styrene-acrylic) copolymer; 8,000 Mw; 10 mg KOH/g
Acid Number; available from BYK Chemie (Germany).
Carbosperse ® K-7208 is a polyacrylic acid; 2,300 Mw; >500 mg KOH/g Acid Number; available from Lubrizol Corp. (USA).

### Example 2—Preparation of White Ink Compositions

Twenty-four (24) white ink compositions were prepared. Seven inks (Inks 1-7) were white ink compositions prepared in accordance with aspects of the present disclosure, and Comparative Inks (C1-C17) were prepared to compare performance with Inks 1-7. The white ink compositions and comparative inks prepared are provided in Tables 2-5, as follows:

TABLE 2
White Ink Compositions (Inks 1-7)
Containing D1 and Polyurethane Binder

| | | Ink 1 | Ink 2 | Ink 3 | Ink 4 | Ink 5 | Ink 6 | Ink 7 |
|---|---|---|---|---|---|---|---|---|
| Component | Category | (wt %) | (wt %) | (wt %) | (wt %) | (wt %) | (wt %) | (wt %) |
| TiO₂ | White | 10 | 10 | 10 | 10 | 10 | 10 | 10 |
| (From D1) | Pigment | | | | | | | |
| Dispercoll ® | PU Binder | 10 | 10 | 10 | 10 | 10 | — | — |
| U42 | | | | | | | | |
| Impranil ® DLN- | PU Binder | — | — | — | — | — | 10 | — |
| SD | | | | | | | | |
| Impranil ® DP | PU Binder | — | — | — | — | — | — | 10 |
| DSB 1069 | | | | | | | | |
| Glycerol | Organic | 15 | — | — | — | — | — | — |
| | Co-solvent | | | | | | | |
| 1,5-pentanediol | Organic | — | 15 | 15 | — | — | — | — |
| | Co-solvent | | | | | | | |
| 1,3-propanediol | Organic | — | — | — | — | 15 | 15 | 15 |
| | Co-solvent | | | | | | | |
| 2-Methyl-1,3- | Organic | — | — | — | 9 | — | — | — |
| propanediol | Co-solvent | | | | | | | |
| Dowanol ® | Organic | — | — | 1 | 1 | 1 | 1 | 1 |
| TPM | Co-solvent | | | | | | | |
| LEG-1 | Organic | 2 | 2 | 2 | 2 | 2 | 2 | 2 |
| | Co-solvent | | | | | | | |
| Surfynol ® 440 | Surfactant | 0.3 | 0.3 | 0.3 | 0.3 | 0.3 | 0.3 | 0.3 |
| Acticide ® B20 | Biocide | 0.04 | 0.04 | 0.04 | 0.04 | 0.04 | 0.04 | 0.04 |

| | | |
|---|---|---|
| Water | Solvent | Balance |

PU Binder refers to polyurethane binder.
Dispercoll ® U42 is an anionic aliphatic polyester-polyurethane dispersion (33,000 Mw; 5.5 mg KOH/g Acid Number), available from Covestro (Germany).
Impranil ® DLN-SD is an anionic aliphatic polyester-polyurethane dispersion (45,000 Mw; 5.2 mg KOH/g Acid Number), available from Covestro (Germany).
Impranil ® DP DSB 1069 is an anionic aliphatic polyether-polyurethane dispersion (95,000 Mw; 3.6 mg KOH/g Acid Number), available from Covestro (Germany)
Dowanol ® TPM is a propylene glycol alkyl ether, available from Dow Chemical (USA).
Surfynol ® 440 is available from Evonik (Germany).
Acticide ® B20 is available from Thor Specialties (USA).

TABLE 3
Comparative White Ink Compositions (C1-C6)
Containing D2 and Polyurethane Binder

| | | C1 | C2 | C3 | C4 | C5 | C6 |
|---|---|---|---|---|---|---|---|
| Component | Category | (wt %) | (wt %) | (wt %) | (wt %) | (wt %) | (wt %) |
| TiO₂ | White | 10 | 10 | 10 | 10 | 10 | 10 |
| (From D2) | Pigment | | | | | | |
| Dispercoll ® U42 | PU Binder | 8 | 8 | — | — | 10 | — |
| Impranil ® DLN- | PU Binder | — | — | 8 | 8 | — | 10 |
| SD | | | | | | | |
| | | — | — | — | — | — | — |
| Glycerol | Organic Co- | 9 | — | 9 | — | — | — |
| | solvent | | | | | | |
| 1,3-propanediol | Organic Co- | — | — | — | — | 15 | 15 |
| | solvent | | | | | | |
| 2-Methyl-1,3- | Organic Co- | — | 9 | — | 9 | — | — |
| propanediol | solvent | | | | | | |
| Dowanol ® TPM | Organic Co- | 1 | 1 | 2 | 1 | 1 | 1 |
| | solvent | | | | | | |
| LEG-1 | Organic Co- | 2 | 2 | 1 | 2 | 2 | 2 |
| | solvent | | | | | | |
| Surfynol ® 440 | Surfactant | 0.3 | 0.3 | 0.3 | 0.3 | 0.3 | 0.3 |
| Acticide ® B20 | Biocide | 0.04 | 0.04 | 0.04 | 0.04 | 0.04 | 0.04 |

| | | |
|---|---|---|
| Water | Solvent | Balance |

TABLE 4
Comparative White Ink Compositions (C7-C9)
Containing D1 and Latex Binder

| Component | Category | C7 | C8 | C9 |
|---|---|---|---|---|
| | | (wt%) | (wt%) | (wt%) |
| TiO₂ | White Pigment | 10 | 10 | 10 |
| (From D1) | | | | |
| Latex 1 | Multi-phase Acrylic | 10 | — | — |
| | Latex Binder | | | |
| Latex 2 | Single-phase Acrylic | — | 10 | — |
| | Latex Binder | | | |
| Latex 3 | Multi-phase Acrylic | — | — | 10 |
| | Latex Binder | | | |
| 1,3-propanediol | Organic Co-solvent | 15 | 15 | 15 |
| Dowanol ® TPM | Organic Co-solvent | 1 | 1 | 1 |
| LEG-1 | Organic Co-solvent | 2 | 2 | 2 |
| Surfynol ® 440 | Surfactant | 0.3 | 0.3 | 0.3 |
| Acticide ® B20 | Biocide | 0.04 | 0.04 | 0.04 |
| Water | Solvent | Balance | | |

Latex 1 is a multi-stage copolymer with Stage 1 being copolymerized butyl acrylate, methyl methacrylate, and methacrylic acid; and Stage 2 being copolymerized cyclohexyl methacrylate, polyhydroxyethyl methacryate, and cyclohexyl acrylate;
Latex 2 is a copolymer of methyl methacrylate, styrene, and butyl acrylate; and Latex 3 is a multi-stage copolymer with stage 1 being copolymerized butyl acrylate and styrene, and Stage 2 being copolymerized methyl methacrylate, styrene, and butyl acrylate.

TABLE 5
Comparative White Ink Compositions (C10-C17)
Containing D2, Polyurethane Binder, and Boehmite

| | | C10 | C11 | C12 | C13 | C14 | C15 | C16 | C17 |
|---|---|---|---|---|---|---|---|---|---|
| Component | Category | (wt %) | (wt %) | (wt %) | (wt %) | (wt %) | (wt %) | (wt %) | (wt %) |
| TiO₂ | White | 10 | 10 | 10 | 10 | 10 | 10 | 10 | 10 |
| (From D2) | Pigment | | | | | | | | |
| Dispercoll ® | PU Binder | 8 | 8 | — | — | — | — | 10 | — |
| U42 | | | | | | | | | |
| Impranil ® | PU Binder | — | — | 8 | 8 | 8 | 8 | — | 10 |
| DLN-SD | | | | | | | | | |
| Glycerol | Organic Co- | — | — | 9 | — | 9 | — | — | — |
| | solvent | | | | | | | | |
| 1,3-propanediol | Organic Co- | — | — | — | — | — | — | 15 | 15 |
| | solvent | | | | | | | | |
| 2-Methyl- | Organic Co- | 9 | 9 | — | 9 | — | 9 | — | — |
| 1,3-propanediol | solvent | | | | | | | | |
| Dowanol ® | Organic Co- | 1 | 1 | 2 | 1 | 2 | 1 | 1 | 1 |
| TPM | solvent | | | | | | | | |
| LEG-1 | Organic Co- | 2 | 2 | 1 | 2 | 1 | 2 | 2 | 2 |
| | solvent | | | | | | | | |
| Surfynol ® | Surfactant | 0.3 | 0.3 | 0.3 | 0.3 | 0.3 | 0.3 | 0.3 | 0.3 |
| 440 | | | | | | | | | |
| Acticide ® | Biocide | 0.04 | 0.04 | 0.04 | 0.04 | 0.04 | 0.04 | 0.04 | 0.04 |
| B20 | | | | | | | | | |
| Boehmite | Dispersed | 0.15 | 0.3 | 0.15 | 015 | 03 | 0.3 | 0.3 | 0.3 |
| | Aluminum | | | | | | | | |
| | Oxide | | | | | | | | |
| | Additive | | | | | | | | |

| | | |
|---|---|---|
| Water | Solvent | Balance |

### Example 3—White Pigment Redispersibility in Inks 1-7 and Comparative Inks C1-C17

The twenty-four (24) white ink compositions prepared in accordance with Example 2 (Tables 2-5) were evaluated for redispersibility based on percentage of pigment recovered after centrifugation and one cycle of remixing. The procedure for the testing protocol was as follows:
40 g of a well-mixed white ink composition is disposed in a 50 mL centrifugation tube.
White ink composition in tube is centrifuged at 1,000 RPM for 2 hours and 25 minutes.
Remixing for a single cycle is then carried out using a Grang Bio PRT-35 Programmable Mixer with the following settings: Orbital at 30 RPM for 2 seconds; Reciprocal at 45° for 5 seconds; Vibro/pulse at 5° for 5 seconds; and Time at 1 minute.
UV-vis abs is measured for samples before centrifugation, after centrifugation, and after remixing cycles using a UV-vis Spectrophotometer.
X-ray images are taken after centrifugation and after remixing cycles, with samples imaged from a vertically central location of the centrifugation tube.
Redispersibility (or % pigment recover) is calculated according to the following formula: % Abs Recovered=Abs (centrifuged sample)/Abs (non-centrifuged sample)*100.

The data collected using this procedure is provided in Table 6, as follows:

TABLE 6
White Pigment Redispersibility in White Ink Compositions

| | % Recovery | |
|---|---|---|
| Ink ID | After Centrifugation | After Remixing (1 cycle) |
| Ink 1 | 54.6 | 87.4 |
| Ink 2 | 49.9 | 85.4 |
| Ink 3 | 49.8 | 87.6 |
| Ink 4 | 44 | 83 |
| Ink 5 | 54.9 | 88 |
| Ink 6 | 42.3 | 86.7 |
| Ink 7 | 63.9 | 98.6 |
| Cl | 22 | 25 |
| C2 | 25 | 30 |
| C3 | 18 | 25 |
| C4 | 16 | 30 |
| C5 | 41.6 | 62 |
| C6 | 40.3 | 58.8 |
| C7 | 40.7 | 59.7 |
| C8 | 37.6 | 68.5 |
| C9 | 35.9 | 61.2 |
| C10 | 25 | 54 |
| C11 | 72 | 74 |
| C12 | 19 | 29 |
| C13 | 19 | 37 |
| C14 | 62 | 66 |
| C15 | 33 | 57 |
| C16 | 54.9 | 88 |
| C17 | 42.3 | 86.7 |

Redispersibility Scale: 90-100% Excellent; 75-90% Good; 50-75% Marginal; 0-50% Poor.

As can be seen from Table 6, Inks 1-7 all exhibited marginal recovery or redispersibility after centrifugation in most cases with excellent redispersibility in Ink 7 in particular, with % recovery values ranging from 83 to 98.6. Comparative Inks C1-C6, which included the high-acid polymer introduced from white pigment dispersion D2 as one of the dispersants exhibited poor to marginal redispersibility. Comparative Inks C7-C9, which included white pigment dispersant D1, but which substituted various acrylic-based latex polymer binders for the polyurethane binders of Inks 1-7, exhibited marginal redispersibility. Comparative Inks C10-17, which included white pigment dispersion D2 with polyurethane binder and separately dispersed boehmite exhibited poor or marginal redispersibility in most instances, with good redispersibility found only in Inks 16 and 17. Though Inks 16 and 17 exhibited good redispersibility, these inks exhibited poor thermal inkjet pen performance, as illustrated in Example 4 below.

### Example 4—White Ink Composition Inkjet Pen Performance

Three (3) white ink compositions prepared in accordance with the present disclosure (Inks 1-3) were compared with six (6) comparative white ink compositions (C10, C11, C14-C17). The comparative inks included a boehmite additive as well as a high-acid polymer (introduced via white pigment dispersion D2). The data collected was related to % missing nozzles, drop weight, and drop volume. The procedure for the testing protocol for these measurements was as follows:
Percent Missing Nozzles (% Missing Nozzles) is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value. The lower value the better.
Drop Weight (DW) is an average drop weight in nanograms (ng) across the number of firing nozzles. The higher the value the better.
Drop Weight 2,000 (DW 2K) is measured using a 2 k-drop mode of firing at 30 KHz, firing 2,000 drops and then measuring/calculating the average white ink composition drop weight in nanograms (ng). The higher the value the better.
Drop Volume (DV) refers to an average velocity of the drop as initially fired from the thermal inkjet nozzles. The higher the value the better.

The measurements taken are provided in Table 7, as follows:

TABLE 7
White Ink Composition Inkjet Pen Performance Comparison

| | % Missing | DW | DW 2K | Dv |
|---|---|---|---|---|
| Ink ID | Nozzles | (ng) | (ng) | (m/s) |
| Ink 1 | 5.2 | 10.7 | 9.4 | 9.9 |
| Ink 2 | 13.0 | 10.5 | 9.6 | 9.7 |
| Ink 3 | 1.0 | 10.1 | 9.6 | 8.0 |
| C10 | 9.4 | 8.2 | 7.2 | 6.8 |
| C11 | 18.8 | 8.6 | 6.9 | 6.5 |
| C14 | 36.5 | 6.7 | 7.1 | 5.7 |
| C15 | 44.8 | 7.9 | 5.1 | 6.3 |
| C16 | 55.2 | 6.1 | 5.8 | 5.0 |
| C17 | 82.3 | 0.0 | 0.0 | 5.4 |

As can be seen from this data, Inks 1-3 outperformed the control inks with respect to both drop weight measurements. With respect to the percent of missing nozzles, Inks 1 and 3 outperformed all of the control inks (with fewer missing nozzles), and only control ink C10 marginally outperformed Ink 2, but taken in connection with the drop weight and drop volume data, Ink 2 outperformed control ink C10 on balance.

While the disclosure has been described with reference to certain embodiments, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. A white ink composition, comprising:
an aqueous ink vehicle including water and organic co-solvent;
from 5 wt % to 30 wt % white metal oxide pigment;
from 0.05 wt % to 1 wt % block copolymer dispersant adsorbed on a surface of the white metal oxide, wherein the block copolymer dispersant has a weight average molecular weight from 5,000 Mw to 20,000 Mw, and an acid number from 0 mg KOH/g to 40 mg KOH/g based on dry weight of the block copolymer dispersant; and
from 2 wt % to 30 wt % polyurethane binder.

2. The white ink composition of claim 1, wherein the white ink composition includes from 50 wt % to 85 wt % water and from 5 wt % to 25 wt % polyol organic co-solvent.

3. The white ink composition of claim 1, wherein the white metal oxide pigment includes titanium dioxide particles, zinc oxide particles, zirconium oxide particles, cerium dioxide particles, or a combination thereof.

4. The white ink composition of claim 1, wherein the white metal oxide pigment has a D50 particle size from greater than 100 nm to 2,000 nm.

5. The white ink composition of claim 1, wherein the block copolymer dispersant is a branched copolymer with polyether pendant chains and acidic groups.

6. The white ink composition of claim 1, wherein the polyurethane binder has a weight average molecular weight from 20,000 Mw to 500,000 Mw and an acid number from 0 mg KOH/g to 40 mg KOH/g based on dry weight of the polyurethane binder.

7. The white ink composition of claim 1, wherein the polyurethane binder is an anionic aliphatic polyester- or polyether-polyurethane.

8. The white ink composition of claim 1, wherein the white ink composition is substantially devoid of dispersed aluminum oxides, dispersed silicon dioxides, and high-acid polymers having an acid number of 100 mg KOH/g or more.

9. A method of making a white ink composition, comprising:
combining a white metal oxide pigment in a water-based carrier with a block copolymer dispersant to form a white metal oxide pigment dispersion, wherein the block copolymer dispersant is adsorbed on a surface of the white metal oxide, and wherein the block copolymer dispersant has a weight average molecular weight from 5,000 Mw to 20,000 Mw and an acid number from 0 mg KOH/g to 40 mg KOH/g based on dry weight of the block copolymer dispersant; and
admixing the white metal oxide pigment dispersion with water, organic co-solvent, and polyurethane binder to form the white ink composition, wherein the white ink composition includes from 5 wt % to 30 wt % of the white metal oxide pigment, from 0.05 wt % to 1 wt % of the polymer dispersant, and from 2 wt % to 30 wt % of the polyurethane binder.

10. The method of claim 9, wherein combining includes milling the white metal oxide pigment with the polymer dispersant.

11. The method of claim 9, wherein the polymer dispersant is a branched copolymer with polyether pendant chains and acidic groups.

12. The method of claim 9, wherein the polyurethane binder has a weight average molecular weight from 20,000 Mw to 500,000 Mw and an acid number from 0 mg KOH/g to 40 mg KOH/g based on dry weight of the polyurethane binder.

13. The method of claim 9, wherein the white ink composition prepared includes from 50 wt % to 85 wt % of the water and from 5 wt % to 25 wt % polyol organic co-solvent.

14. A method of printing a white ink composition, comprising:
remixing a white ink composition including an aqueous ink vehicle, white metal oxide pigment, block copolymer dispersant, and a polyurethane binder, wherein remixing causes re-suspension of the white metal oxide pigment that has settled in the aqueous ink vehicle, wherein the block copolymer dispersant is adsorbed on a surface of the white metal oxide, wherein the block copolymer dispersant has a weight average molecular weight from 5,000 Mw to 20,000 Mw and an acid number from 0 mg KOH/g to 40 mg KOH/g based on dry weight of the block copolymer dispersant; and
ejecting the white ink composition from an inkjet printhead after the white metal oxide pigment has been re-suspended.

15. The method of claim 14, wherein remixing is carried out by:
rotation of an ink cartridge or supply containing the white ink composition,
recirculation of the white ink composition within fluidics of a printer, within the ink cartridge or supply, or both,
agitation of the white ink composition within the ink cartridge or supply, or
a combination thereof.
